(19) United States
(12) Patent Application Publication
(10) Pub. No.: US 2019/0174929 A1
(43) Pub. Date: Jun. 13, 2019

(54) Support Bed for Pregnant Women

(71) Applicant: Amy Page, Darwin (AU)

(72) Inventor: Amy Page, Darwin (AU)

(21) Appl. No.: 15/922,135

(22) Filed: Mar. 15, 2018

(30) Foreign Application Priority Data
Dec. 12, 2017 (AU) 2017905191

(51) Int. Cl. A47C 20/02; A47C 27/08

(52) U.S. Cl. CPC A47C 20/025; A61G 7/05723; A61G 2200/12; A47C 27/081

(57) ABSTRACT

A support bed comprising an inflatable body having a first opening adapted to receive a distended abdominal area of a person, wherein the body has one or more flexible portions which divide the body into sections and allow one section to rotate with respect to another section.

### TECHNICAL FIELD

The present invention relates to support beds for people with distended abdominal areas and, more particularly to a support bed for pregnant women.

### BACKGROUND

Pregnant women find it difficult to get comfortable, particularly during the late stages of pregnancy. They can lay on their back, but this can cut off the blood supply and oxygen to the foetus and mother. Pregnant women also experience pressure on the lungs and internal organs. A pregnant woman can lie on her side, but must continue to rotate from side to side in order to relieve pressure and maintain comfort. Pregnancy can deprive women of sleep, particularly if they are used to sleeping on their stomach.

Leisure activities which require women to lie down are typically restricted during pregnancy. For example, women cannot easily participate in mainstream massages, sunbaking on the beach, or lying on the ground to read to a book in the park. Movement and exercises are also typically restricted during pregnancy.

Examination and treatment from who require patients to lie down can also be restricted. Accordingly, it becomes more difficult for pregnant women to receive treatment from physiotherapists, chiropractors and osteopaths.

Another problem is that sometimes foetuses do not turn into the ideal delivery position for birthing. During the last trimester of pregnancy, pregnant women are often advised by medical practitioners to assume a position on all fours to allow the foetus to turn naturally with the assistance of gravity into a position where the back of the foetus faces the front of the pregnant woman. This position is also often assumed during labour. However, it can be uncomfortable and exerting for pregnant women to hold this position for long periods of time.

There is a need for a device which makes women's pregnancies more enjoyable and less restrictive when compared to their normal life. The object of the present invention is to overcome or at least substantially ameliorate the aforementioned problems.

### SUMMARY OF THE INVENTION

According to the present invention, there is provided a support bed comprising an inflatable body having a first opening adapted to receive a distended abdominal area of a person, wherein the body has one or more flexible portions which divide the body into sections and allow one section to rotate with respect to another section.

Preferably, the body has a second opening adapted to receive a bust area of the person. The bed may include a support band for supporting at least part of the weight in the first opening of the distended abdominal area of the person. The bed may include plugs for the first or the second opening. The body may be adapted to be inflated to adjust the size of the first opening or the second opening.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a perspective view of a support bed according to an embodiment of the present invention.

FIG. 2 is a top view of the support bed of FIG. 1.

FIG. 3 is a side view of the support bed of FIG. 1 in a folded form.

FIG. 4 is a perspective view of the support bed of FIG. 1 folded in the back seat and boot of a car.

FIG. 5 is a side section view of a woman using the support bed of FIG. 1.

FIG. 6 is a perspective view of the woman of FIG. 5 using the support bed of FIG. 1.

FIG. 7 is a perspective view of plug being inserted into the opening for the abdomen area in the support bed of FIG. 1.

FIG. 8 is a perspective view of the support bed of FIG. 8 with a support band over the opening for the opening for the abdomen area in the support bed of FIG. 1.

### DETAILED DESCRIPTION

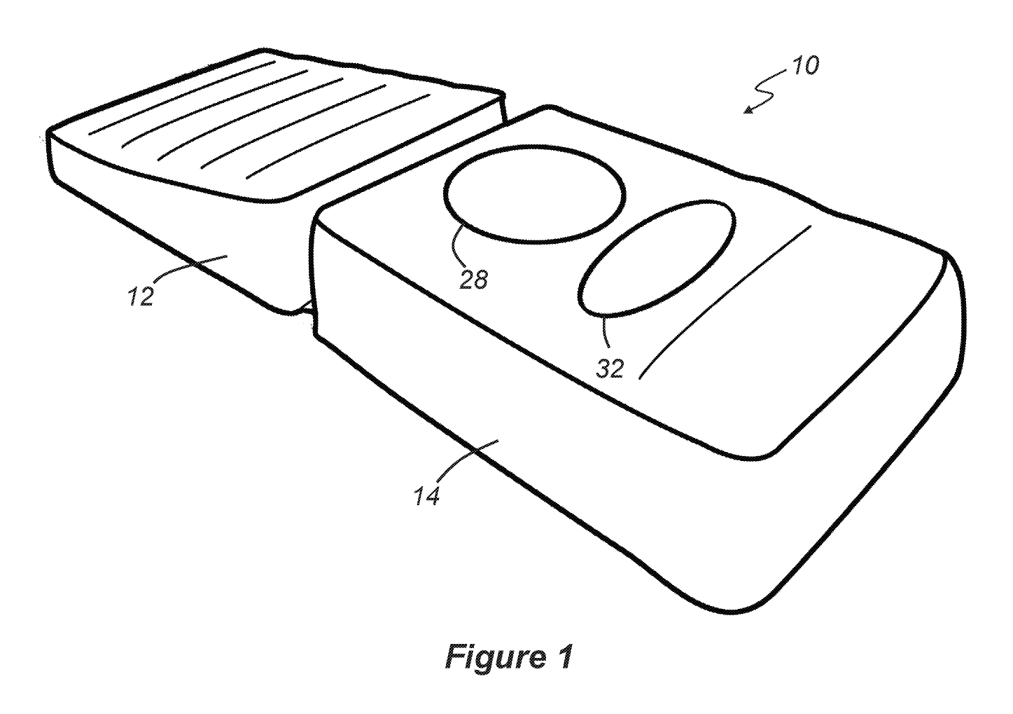

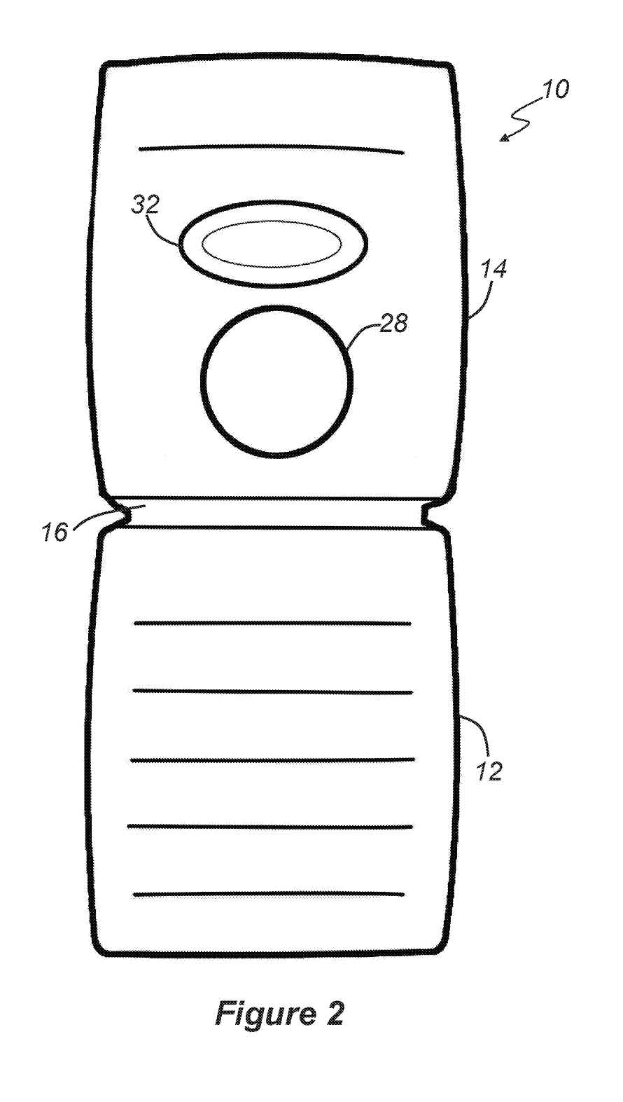

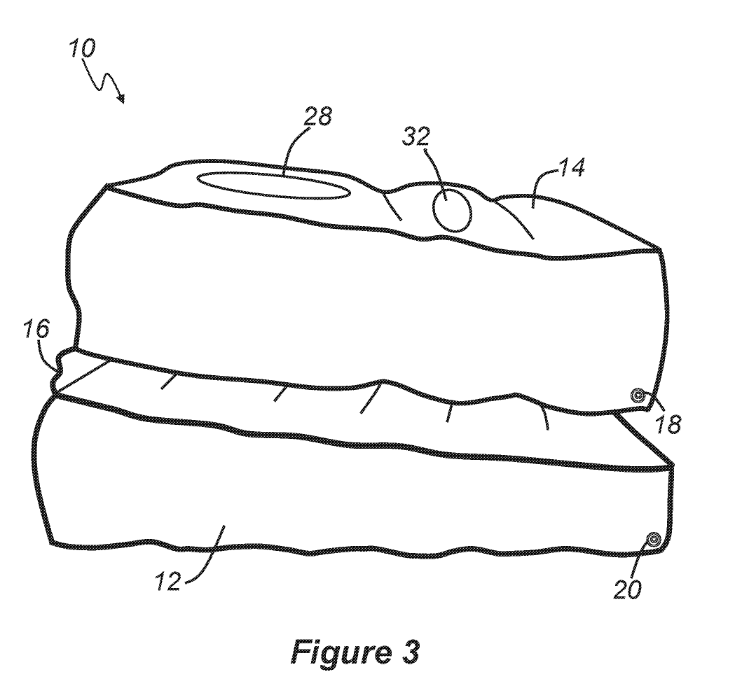

A support bed 10 according to an embodiment of the present invention is shown in FIG. 1. The support bed 10 has an upper section 12 and a lower section 14 connected by a flexible portion 16 (see FIG. 2). The support bed 10 is inflatable and each section 12 and 14 can be inflated using the air intake valves 18 and 20 shown in FIG. 3. The inflatable nature of the support bed 10 allows the firmness of the bed 10 to be customised by a person using the bed 10.

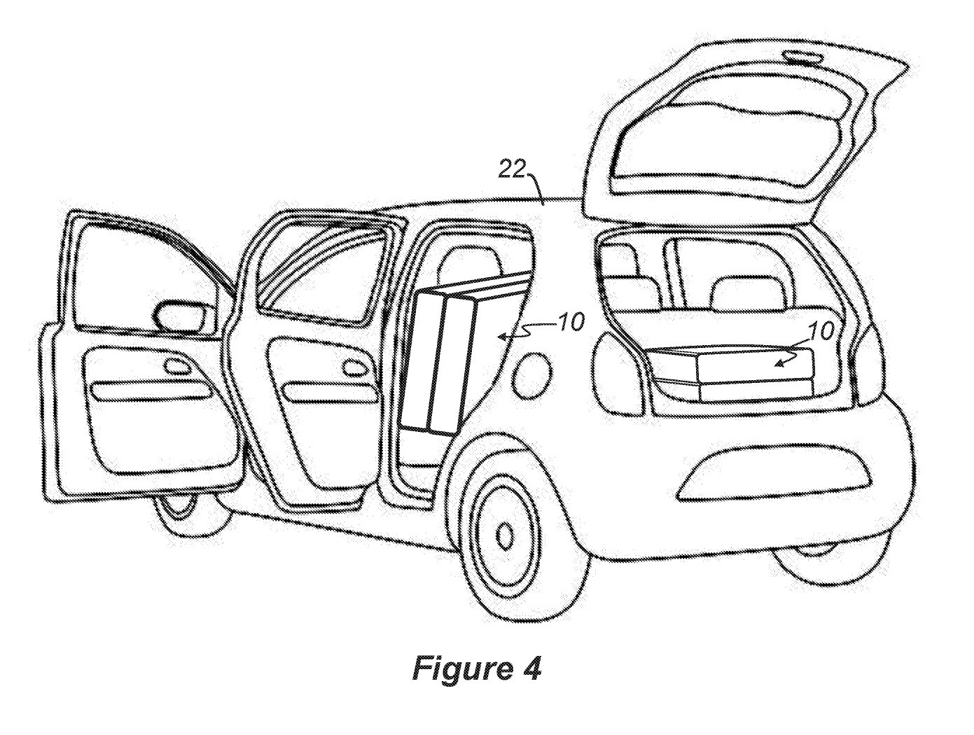

The flexible portion 16 allows the upper section 12 and the lower section 14 to be folded over one another as shown in FIG. 3. This allows the support bed 10 to be easily stored or transported. FIG. 4 shows two support beds 10 being folded and stored in the back seat and boot of a car 22. The flexible portion 16 avoids the need to deflate the support bed 10 during storage and transport, which is a problem not considered or solved in prior art support beds. Inflating the support bed after storage or transport can be a laborious activity, particularly for pregnant women.

The flexible portion 16 also allows the support bed to be positioned over furniture so that a pregnant woman can be positioned with her legs at an angle to her torso. This position is particularly comfortable position for women during childbirth. It allows the foetus to turn naturally with the assistance of gravity into a position where the back of the foetus faces the front of the pregnant woman.

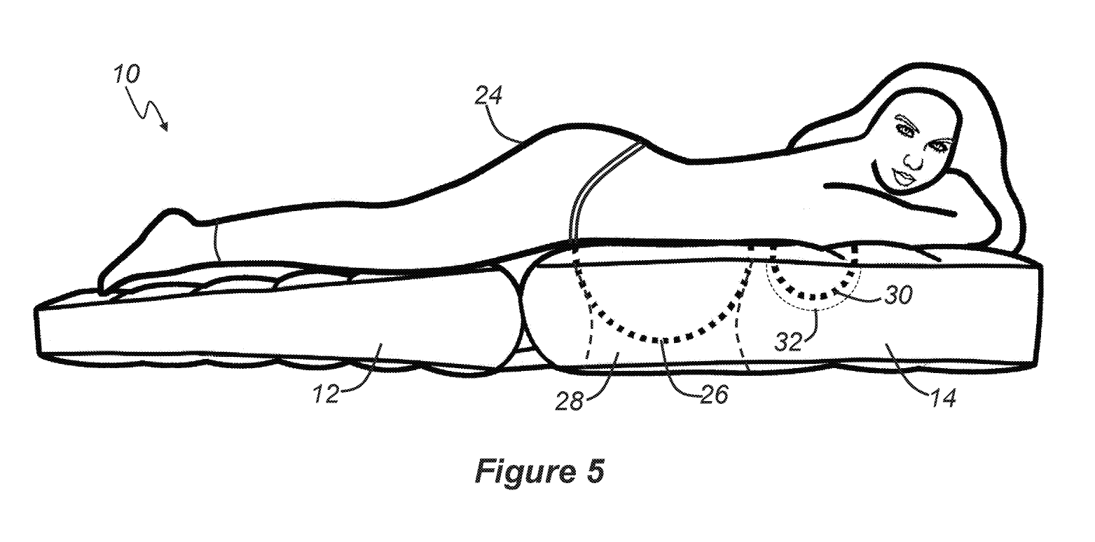

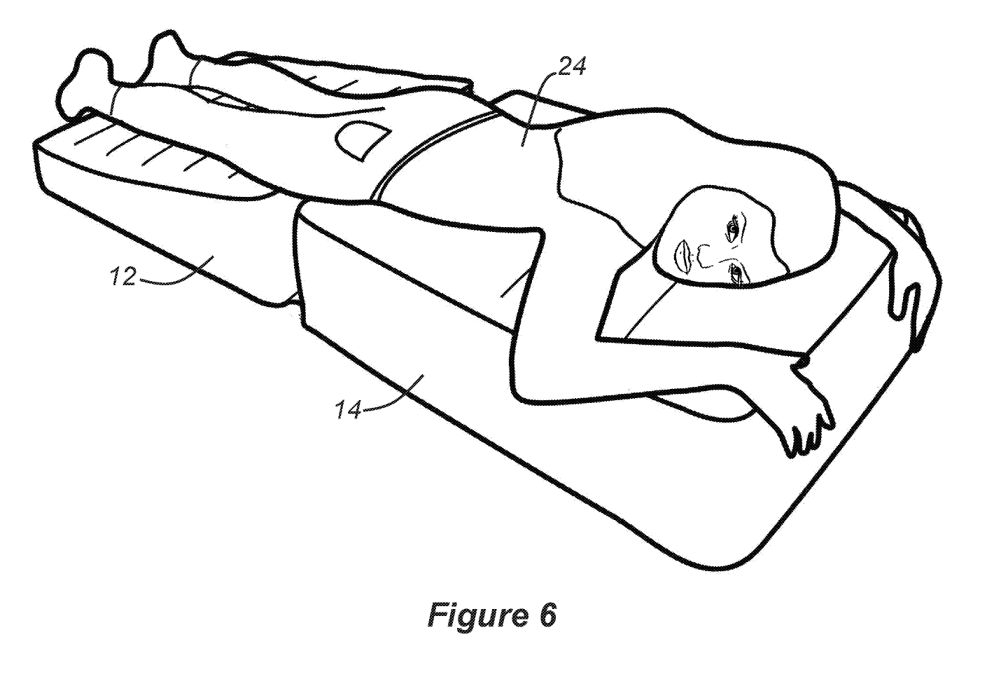

The support bed 10 is shown in use in FIGS. 5 and 6. A pregnant woman 24 is lying on the support bed 10 with her distended abdomen 26 extending through the opening 28 and her breasts 30 extending through the opening 32. The opening 28 allows the woman 24 to relieve the pressure on her internal organs caused by the foetus in the distended abdomen 26. The opening 32 can relieve the pressure in the swollen breasts 30 of the pregnant woman 24, which is a problem not considered or solved in prior art support beds.

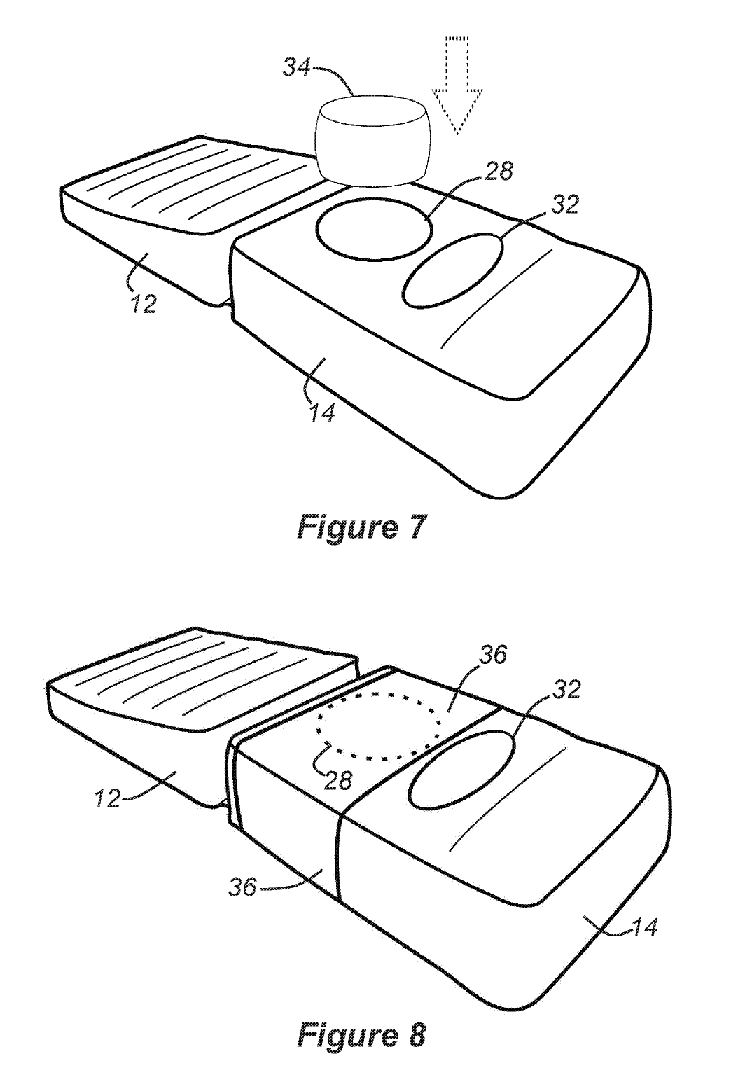

FIG. 7 shows a plug 34 for the first opening 28, so that a person without a distended abdomen can have their abdomen supported by the bed 10. This embodiment of the invention could be particularly useful for women who have recently had breast augmentation, but like to lie on their stomachs when they sleep.

A support band 36 can be used to cover the first opening 28 as shown in FIG. 8. The band 36 provides support for the distended abdomen, reduces the potential for stretch marks on the torso from the weight of the foetus and relieves pressure on the back of the person using the support bed 10. This embodiment of the invention could be useful for a woman who has recently given birth or is at an early stage of gestation when her abdomen is not particularly distended.

In some embodiments of the invention, the openings 28 and 32 have integrally built inflatable sub-sections (not shown) which can be independently inflated to accommodate and support the particular size of the distended abdomen or breasts of the person using the support bed 10.

### CONCLUDING REMARKS

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A support bed comprising an inflatable body having a first opening adapted to receive a distended abdominal area of a person, wherein the body has one or more flexible portions which divide the body into sections and allow one section to rotate with respect to another section.

2. The support bed of claim 1, wherein the body has a second opening adapted to receive a bust area of the person.

3. The support bed of claim 1, wherein the bed includes a support band for supporting at least part of the weight in the first opening of the distended abdominal area of the person.

4. The support bed of claim 1, wherein the bed includes plugs for the opening.

5. The support bed of claim 1, wherein the body is adapted to be inflated to adjust the size of the first opening or the second opening.
